(19) United States
(12) Patent Application Publication
(10) Pub. No.: US 2004/0140459 A1
(43) Pub. Date: Jul. 22, 2004

(54) Enhanced shadow reduction system and related techniques for digital image capture

(76) Inventors: Scott D. Haigh, Canton, MA (US); Tuan A. Hoang, Westford, MA (US); Charles F. Duggan, Merrimack, NH (US); David Bohaker, Chelmsford, MA (US); Leo M. Kenen, Bedford, MA (US)

Correspondence Address: Marianne McLaughlin Downing, Suite 250, 19801 SW 72nd Avenue, Tualatin, OR, 97062, US

(21) Appl. No.: 10/663,439

(22) Filed: Sep. 15, 2003

Related U.S. Application Data
(60) Provisional application No. 60/410,544, filed on Sep. 13, 2002.
(60) Provisional application No. 60/447,502, filed on Feb. 13, 2003.

(51) Int. Cl. H01C 13/00

(52) U.S. Cl. 252/501.1

(57) ABSTRACT

A lighting device for illuminating an object from a light source includes a housing having an inner surface portions of which are diffusely reflective and an aperture disposed in the housing aligned with the light source. The lighting device further includes a diffuser positioned between the light source and the object and a reflector disposed adjacent the aperture between the light source and the diffuser.

### CLAIM OF PRIORITY

This application claims the priority of the following United States Provisional Applications, the contents of which are incorporated herein by reference in their entirety

“Shadow Reduction System and Related Techniques for Digital Image Capture”, (application Ser. No. 60/410,544), Attorney Docket No. P0689, inventors Scott Haigh and Tuan A. Hoang, filed Sep. 13, 2002;

“Enhanced Shadow Reduction System and Related Techniques for Digital Image Capture”, (application Ser. No. 60/447,502), Attorney Docket No. P0789, inventors Scott Haigh, Tuan a. Hoang, Charles R. Duggan, David Bohaker, and Leo Kenen, filed Feb. 13, 2002;

### RELATED APPLICATION DATA

This application is also related to the following U.S. provisional and non-provisional patent applications:

Laser Engraving Methods and Compositions, and Articles Having Laser Engraving Thereon (application Ser. No. 10/326,886, Attorney Docket No. P0724D, filed Dec. 20, 2002—Inventors Brian Labrec and Robert Jones);

Multiple Image Security Features for Identification Documents and Methods of Making Same (application Ser. No. 10/325,434, Attorney Docket No. P028D, filed Dec. 18, 2002—Inventors Brian Labrec, Joseph Anderson, Robert Jones, and Danielle Batey);

Covert Variable Information on Identification Documents and Methods of Making Same (application Ser. No. 10/330032, Attorney Docket No. P0732D, filed Dec. 24, 2002—Inventors: Robert Jones and Daoshen Bi);

Systems, Compositions, and Methods for Full Color Laser Engraving of ID Documents (application Ser. No. 10/330,034, Attorney Docket No. P0734D, filed Dec. 24, 2002—Inventor Robert Jones)

Systems and Methods for Recognition of Individuals Using Combination of Biometric Techniques (application Ser. No. 60/418,129, Attorney Docket No. P0698D, filed Oct. 11, 2002—Inventors James V. Howard and Francis Frazier); and

Systems and Methods for Managing and Detecting Fraud in Image Databases Used With Identification Documents (application Ser. No. 60/429,501, Attorney Docket No. P0718D, filed Nov. 26, 2003—Inventors James V. Howard and Francis Frazier).

Each of the above U.S. Patent documents is herein incorporated by reference in its entirety. The present invention is also related to U.S. patent application Ser. Nos. 09/747,735, filed Dec. 22, 2000, 09/602,313, filed Jun. 23, 2000, and 10/094,593, filed Mar. 6, 2002, U.S. Provisional Patent Application No. 60/358,321, filed Feb. 19, 2002, as well as U.S. Pat. No. 6,066,594. Each of the above U.S. Patent documents is herein incorporated by reference.

### TECHNICAL FIELD

The present invention generally relates to identification and security documents, and in particular, relates to enhancing the formation an image on such documents. Embodiments of the invention also relate to image capture systems and more particularly to lighting systems and techniques for reducing shadows and improving image quality in c captured images, including but not limited to digitally captured images.

### BACKGROUND

Identification Documents

Identification documents (hereafter “ID documents”) play a critical role in today's society. One example of an ID document is an identification card (“ID card”). ID documents are used on a daily basis—to prove identity, to verify age, to access a secure area, to evidence driving privileges, to cash a check, and so on. Airplane passengers are required to show an ID document during check in, security screening and prior to boarding their flight. In addition, because we live in an ever-evolving cashless society, ID documents are used to make payments, access an automated teller machine (ATM), debit an account, or make a payment, etc.

(For the purposes of this disclosure, ID documents are broadly defined herein, and include, e.g., credit cards, bank cards, phone cards, passports, driver's licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.).

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image; the cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents”.

As those skilled in the art know, ID documents such as drivers licenses can contain information such as a photographic image, a bar code (which may contain information specific to the person whose image appears in the photographic image, and/or information that is the same from ID document to ID document), variable personal information, such as an address, signature, and/or birthdate, biometric information associated with the person whose image appears in the photographic image (e.g., a fingerprint), a magnetic stripe (which, for example, can be on the a side of the ID document that is opposite the side with the photographic image), and various security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

An exemplary ID document can comprise a core layer (which can be pre-printed), such as a light-colored, opaque material (e.g., TESLIN (available from PPG Industries) or polyvinyl chloride (PVC) material). The core is laminated with a transparent material, such as clear PVC to form a so-called “card blank”. Information, such as variable personal information (e.g., photographic information), is printed on the card blank using a method such as Dye Diffusion Thermal Transfer (“D2T2”) printing (described further below and also described in commonly assigned U.S. Pat. No. 6,066,594, which is incorporated herein by reference in its entirety.) The information can, for example, comprise an indicium or indicia, such as the invariant or nonvarying information common to a large number of identification documents, for example the name and logo of the organization issuing the documents. The information may be formed by any known process capable of forming the indicium on the specific core material used.

To protect the information that is printed, an additional layer of transparent overlaminate can be coupled to the card blank and printed information, as is known by those skilled in the art. Illustrative examples of usable materials for overlaminates include biaxially oriented polyester or other optically clear durable plastic film.

In the production of images useful in the field of identification documentation, it may be desirable to embody into a document (such as an ID card, drivers license, passport or the like) data or indicia representative of the document issuer (e.g., an official seal, or the name or mark of a company or educational institution) and data or indicia representative of the document bearer (e.g., a photographic likeness, name or address). Typically, a pattern, logo or other distinctive marking representative of the document issuer will serve as a means of verifying the authenticity, genuineness or valid issuance of the document. A photographic likeness or other data or indicia personal to the bearer will validate the right of access to certain facilities or the prior authorization to engage in commercial transactions and activities.

Identification documents, such as ID cards, having printed background security patterns, designs or logos and identification data personal to the card bearer have been known and are described, for example, in U.S. Pat. No. 3,758,970, issued Sep. 18, 1973 to M. Annenberg; in Great Britain Pat. No. 1,472,581, issued to G. A. O. Gesellschaft Fur Automation Und Organisation mbH, published Mar. 10, 1976; in International Patent Application PCT/GB82/00150, published Nov. 25, 1982 as Publication No. WO 82/04149; in U.S. Pat. No. 4,653,775, issued Mar. 31, 1987 to T. Raphael, et al.; in U.S. Pat. No. 4,738,949, issued Apr. 19, 1988 to G. S. Sethi, et al.; and in U.S. Pat. No. 5,261,987, issued Nov. 16 1993 to J. W. Luening, et al. All of the aforementioned documents are hereby incorporated by reference.

Image Capture for Identification Documents

In image capture applications for identification systems, it is often desirable to provide controlled lighting in order to produce high-quality images. Conventional systems may use controlled lighting to illuminate the subject to overcome changing ambient light conditions. Some conventional systems use an electronically controlled strobe or flash unit synchronized with a digital image capture device (e.g. a video camera or a digital camera) to illuminate a subject during image capture.

Conventional identification systems, such as systems to generate driver licenses, may use a backdrop placed behind an object to provide a uniform background. The backdrops can vary in color to indicate different types of information, such as whether the driver is under age twenty-one. When a subject is illuminated with a conventional strobe or flash lighting device, a shadow of the subject may appear on the backdrop, and the shadow image may be captured by the image capture device. The shadows, which are visible in the captured image, may be reproduced on identification documents produced from the captured image.

Shadows in the captured images can produce unwanted artifacts in identification documents; in particular, the artifacts may be noticeable on documents printed with a limited number of grayscale levels. Although such artifacts may be less noticeable on some full color documents, they may still be unwanted. In addition, some types of biometric systems, such as some types of facial recognition systems, can be impacted by the presence of shadows.

Some systems have attempted to automatically process digital portrait images to remove unwanted background effects using image-processing techniques, but hair and lighting variations complicate this process and produce objectionable artifacts. Some identification programs permit the use of portrait photographs as the image source. The portrait photographs may be produced in a photographer's studio and the photographs are electronically scanned to produce a digital image, instead of digitally capturing the images with an image capture workstation. Portrait photographs may be taken under controlled lighting conditions using multiple light sources and umbrella diffusers to reduce shadows in the resulting photographs. However, in high volume applications that use images, such as drivers license programs, facial recognition surveillance and/or authentication systems, or national ID programs, it may not be feasible to use portrait photographs submitted by the applicant as the image source. For operational and security reasons the issuing agency may want to retain control of the image capture process.

Artifacts, such as darkened areas adjacent to the subject's ears, can result from shadows, and these artifacts may be accentuated by the use of limited grayscale level identification documents. These artifacts can detract from the appearance of the identification document. An example of an exemplary artifact (e.g., 56a and 56b) is shown in FIG. 4. In addition, the use of an electronic strobe in some image capture applications may cause unwanted reflections (e.g., 60a and 60b) from items such as eyeglasses and bifocal lenses. In addition, the strobe light sometimes creates harsh skin tones in resulting color images. FIG. 4 is discussed even further below.

It would, therefore, be desirable to provide a lighting device and system for illuminating an object which may overcome at least some problems with the ambient light without generating shadows, eyeglass reflections, and harsh skin tones in the resulting captured image.

### SUMMARY

In accordance with one embodiment of the present invention, a lighting device for illuminating an object from a light source includes a housing having inner surface portions. At least a portion of the housing is diffusely reflective. An aperture disposed in the housing is substantially aligned with the light source. The lighting device further includes a diffuser positioned between the light source and the object and a reflector disposed adjacent the aperture between the light source and the diffuser. With such an arrangement, problems with variations in captured image quality due to changes in the ambient light may be reduced for preventing objectionable shadows, eyeglass reflections, and harsh skin tones in image. The lighting device and image capture device can produce a quality image that appears substantially without objectionable shadows and reflections. The lighting device can be mounted on existing capture stands without modification of the light source, image capture device, or the image capture station software.

In one embodiment, the lighting device is used with a strobe or flash unit to provide a diffused, high quality light of appropriate intensity to illuminate a subject such that a captured image (e.g., a digitally captured image) includes minimal reflections and minimal visible shadows created by the relatively harsh direct strobe light. In particular, this lighting device can help to reduce visible shadows on a backdrop or on the subject's hair, face, neck, etc., which may appear as darkened regions located adjacent to a subject's ears and chin in an image captured with a department of motor vehicle (DMV) or identification system capture workstation, where an image capture device directly faces the subject.

The inventive lighting device allows for the capture of relatively high quality ID images under a range of ambient lighting conditions. The captured images may be relatively well suited for facial recognition, as the glare from the subject's eyeglasses and forehead is reduced as compared to known systems. The device also provides diffuse lighting, which produces an image having more accurate skin tones than those produced in conventional systems.

In accordance with a further aspect of the present invention, the housing, diffuser, and reflector are arranged to substantially reduce a visible shadow of the object on a backdrop in an image captured by an image capture device. An advantageous aspect of at least one embodiment of the present invention is that the diffuser and reflector together provide sufficient side illumination while preventing the light source from directly illuminating the subject and producing shadows on a backdrop which are visible by the capture device.

At least some embodiments of the invention have applicability wherever a high-quality image of a subject is required, including applications such as production of identification and/or security documents (including but not limited to drivers licenses and identification cards), biometric systems such as surveillance and/or authentication systems (especially systems that use all or part of a subject's face, such as face recognition systems, iris recognition systems, etc.), photograph “booths”, automated image capture systems, and even uses by amateur and professional photographers.

In one embodiment we provide a lighting device that illuminates an object from a light source, the lighting device comprising a housing an aperture, a diffuser, and a reflector. The housing has at least one inner surface portion that is diffusely reflective. The aperture is disposed in the housing and is aligned with the light source. The diffuser is disposed between the light source and the object. The reflector is disposed adjacent the aperture between the light source and the diffuser. The light source can have illumination, such that reflector is constructed and arranged to intercept the illumination from the light source, the diffusively reflective inner surface portion of the housing is constructed and arranged to reflect the illumination intercepted by the reflector, and the diffuser is constructed and arranged to receive the illumination reflected by the diffusively reflective inner surface of the housing

In another aspect, the invention provides a lighting device for illuminating an object comprising a housing, a light source, a diffuser, and a reflector. The housing has an inner surface, at least a portion of the inner surface being diffusely reflective. The light source, which can be a strobe and which can include a strobe diffuser, is disposed in the housing. The diffuser is positioned between the light source and the object. The reflector is disposed adjacent the aperture between the light source and the diffuser.

In a further aspect, the invention provides a method of illuminating an object with a light source and capturing an image of the object with an image capture device. A diffuser is provided that diffuses light directed directly toward the object. A portion of the light from the light source for illuminating the object is reflected such that substantially all the shadows within the field of view of the image capture device are located behind the object. The reflecting can comprise providing a pair of mirrors for reflecting a portion of the illumination from the light source off a diffusely reflective surface onto the object.

In another aspect, the invention provides a lighting device for illuminating an object from a light source so that an image capture device can capture an image of the object, comprising a light source and means for illuminating the object such that substantially all shadows of the object within the field of view of the image capture device are located behind the object.

The foregoing and other objects, aspects, features, and advantages of this invention will become even more apparent from the following description and drawings, and from the claims.

### BRIEF DESCRIPTION OF THE DRAWINGS

The foregoing features of this invention, as well as the invention itself, may be more filly understood from the following description and the drawings in which:

FIG. 1 is a view of a prior art capture stand and lighting device;

FIG. 2 is schematic view of visible shadows formed on a backdrop using the prior art capture stand and lighting device of FIG. 1;

FIG. 3 is an illustration of a captured image from the prior art system of FIG. 1 useful in illustrating shadow, reflection and skin tone problems;

FIG. 4 is a schematic view of an identification document using the captured image of FIG. 3 from the prior art capture stand;

FIG. 5 is schematic view of an exemplary lighting device attached to a capture stand in accordance with an embodiment of the invention;

FIG. 6 is a diagrammatic perspective view of a portion of a lighting device according to an embodiment of the invention;

FIG. 7 is schematic view of reduced shadows formed on a backdrop using the capture stand and lighting device of FIG. 5;

FIG. 8 is an illustration of an image captured using the capture stand of FIG. 5 illustrating reduced shadows, reflections and skin tone problems;

FIG. 9 is a schematic view of an identification document using the an image captured using the capture stand and lighting device of FIG. 5;

FIG. 10 is a front cross section view of the lighting device of FIG. 5;

FIGS. 11A-C are front, side, and enlarged schematic views, respectively, of a lighting device in accordance with one embodiment of the invention;

FIG. 12 is a diagrammatic front perspective view of a portion a lighting device in accordance with one embodiment of the invention;

FIG. 13 is a diagrammatic exploded perspective view of the lighting device of FIG. 12;

FIG. 14 is a diagrammatic rear perspective view of the lighting device of FIG. 12;

FIGS. 15A-C are cross sectional views taken along the A-A, B-B, and C-C lines, respectively, of FIG. 12;

FIGS. 16A-E are illustrative examples of cross sectional views of some embodiments of the lighting device of FIG. 12;

FIGS. 17A and 17B are illustrative examples of captured “before and after” images, respectively, of a first subject, taken without and with the use of the lighting device of FIGS. 11A-11C;

FIGS. 18A and 18B are illustrative examples of captured “before and after” images, respectively, of a second subject, taken without and with the use of the lighting device of FIGS. 11A-11C; and

FIGS. 19A and 19B are illustrative examples of captured “before and after” images, respectively, of a third subject, taken without and with the use of the lighting device of FIGS. 11A-11C;

The drawings are not necessarily to scale, emphasis instead is generally placed upon illustrating the principles of the invention. In addition, in the drawings, like reference numbers indicate like elements. Further, throughout this application, certain indicia, information, identification documents, data, etc., may be shown as having a particular cross sectional shape (e.g., rectangular) but that is provided by way of example and illustration only and is not limiting, nor is the shape intended to represent the actual resultant cross sectional shape that occurs during manufacturing of identification documents.

### DETAILED DESCRIPTION OF THE INVENTION

Before providing a detailed description of the invention, it may be helpful to define some of the terms used in the description.

In the foregoing discussion, the use of the word “ID document” or “identification document” or “security document” is broadly defined and intended to include all types of ID documents, including (but not limited to), documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, network access cards, employee badges, debit cards, security cards, visas, immigration documentation, national ID cards, citizenship cards, social security cards, security badges, certificates, identification cards or documents, voter registration and/or identification cards, police ID cards, border crossing cards, security clearance badges and cards, legal instruments, gun permits, badges, gift certificates or cards, membership cards or badges, and tags. Also, the terms “document,” “card,” “badge” and “documentation” are used interchangeably throughout this patent application.). In at least some aspects of the invention, ID document can include any item of value (e.g., currency, bank notes, and checks) where authenticity of the item is important and/or where counterfeiting or fraud is an issue.

In addition, in the foregoing discussion, “identification” at least refers to the use of an ID document to provide identification and/or authentication of a user and/or the ID document itself. For example, in a conventional driver's license, one or more portrait images on the card are intended to show a likeness of the authorized holder of the card. For purposes of identification, at least one portrait on the card (regardless of whether or not the portrait is visible to a human eye without appropriate stimulation) preferably shows an “identification quality” likeness of the holder such that someone viewing the card can determine with reasonable confidence whether the holder of the card actually is the person whose image is on the card. “Identification quality” images, in at least one embodiment of the invention, include covert images that, when viewed using the proper facilitator (e.g., an appropriate light or temperature source), provide a discernable image that is usable for identification or authentication purposes.

Further, in at least some embodiments, “identification” and “authentication” are intended to include (in addition to the conventional meanings of these words), functions such as recognition, information, decoration, and any other purpose for which an indicia can be placed upon an article in the article's raw, partially prepared, or final state. Also, instead of ID documents, the inventive techniques can be employed with product tags, product packaging, business cards, bags, charts, maps, labels, etc., etc., particularly those items including marking of an laminate or over-laminate structure. The term ID document thus is broadly defined herein to include these tags, labels, packaging, cards, etc.

The term “diffusely reflective,” as used herein, refers at least to a quality of being able to disperse incident light over a broad range of reflected angles of azimuth and elevation with respect to an object being illuminated. In some instances, the dispersed light having reduced intensity can approach substantially complete coverage over the area where the light is directed. The dispersion of light need not be uniform, but can be. A surface can, for example, be diffusively reflective. Further, the surface need not be a solid surface, but can be composed of a plurality of individual elements, or can comprise a layered arrangement of two or more elements. The term “diffuser,” as used herein, refers to at least a structure, or arrangement of elements that shields a light source and spreads the light substantially evenly in two or more directions. Advantageously, a diffuser can evenly spread light in all directions. Diffusers can be made from virtually any material capable of diffusing light, including but not limited to glass, plastic, paper, fabric, mesh (formed, for example, from wire, metal, thread, glass fibers, etc.), etc. Diffusers generally are translucent but, in some instances, can be transparent.

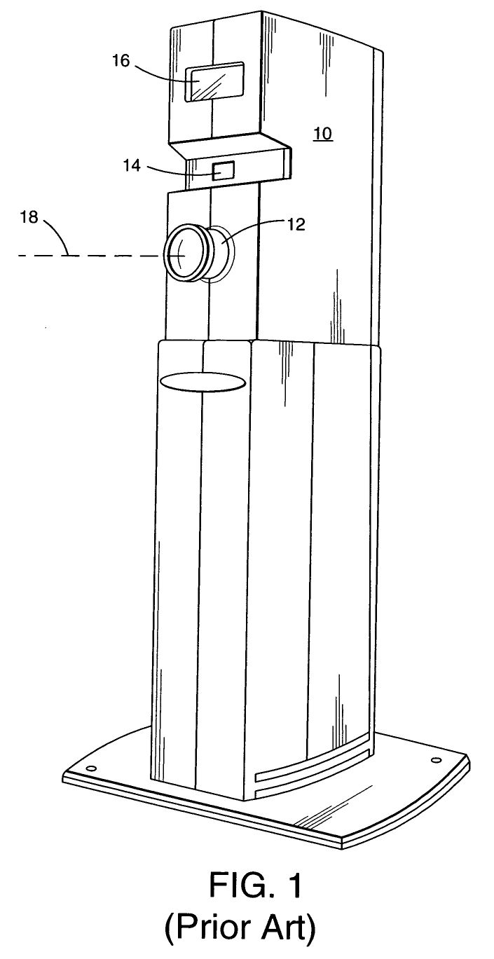

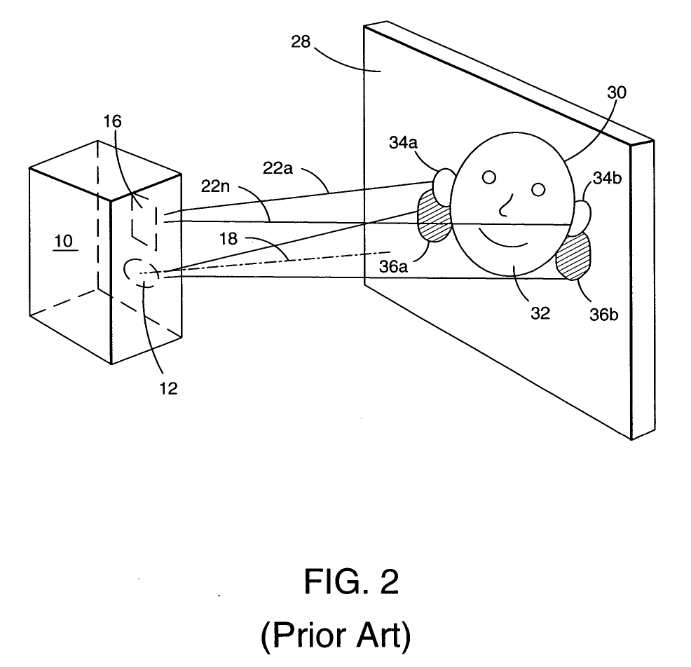

FIG. 1 illustrates a prior art capture stand 10, that includes an image capture device 12, such as a video camera and lens, a light sensor 14, and an light source 16. In operation, the capture stand 10 is controlled by a capture workstation (not shown) to provide light directed toward the subject 30 (FIG. 2) and to capture a digital image of the subject 30. Together, the light sensor 14, and a light source 16 operate as a lighting device. An exit aperture plane can be defined to include the surface of the light source 16 through which the light is directed. The image capture device 12 has an observation axis 18 which is orthogonal to the exit aperture plane of the light source 16. In one embodiment, the light sensor 14 is provided by a strobe sensor, and the light source 16 is an electronic strobe. The light sensor 14 provides a real time adjustment to the light source 16 illumination of the subject by sampling light reflected off the subject and directed back to the light sensor 14. The strobe can optionally include a diffuser cover (not shown).

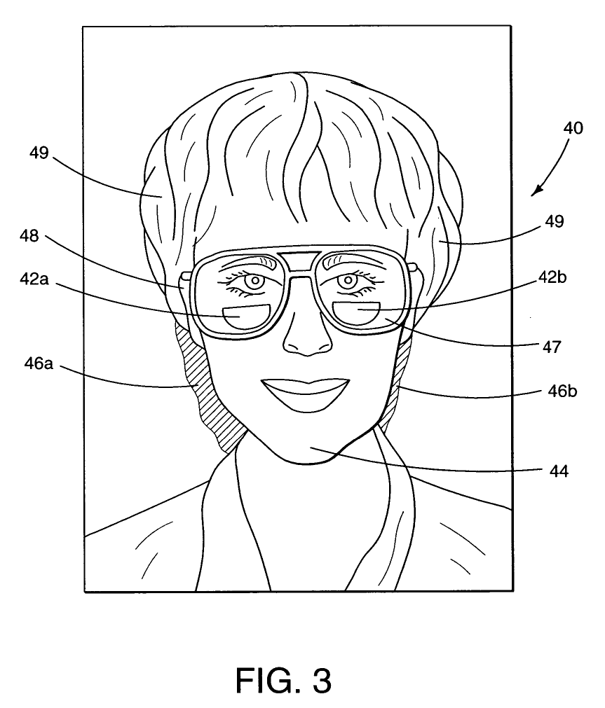

Referring now to FIG. 2, an arrangement for capturing a digital image of a subject 30 located in front of a backdrop 28 includes the capture stand 10 of FIG. 1 disposed directly facing the subject 30. The subject 30, which is provided by way of example only, has a head 32 and ears 34a and 34b. The subject's ears 34a and 34b and hair are disposed on the sides of the head 32 and protrude slightly from the head 32. When commanded by the capture workstation (not shown), the light source 16 provides illumination which can be considered a plurality of light beams 22a-22n directed toward the subject 30. Because the light source 16 output aperture, in one embodiment, is typically shorter in length and width (as measured on the exit aperture plane of the light source 16) than the length and width of the subject's head 32 (as projected on the exit aperture plane of the light source 16), shadows 36a and 36b are formed on a backdrop 28 and appear from the viewpoint of the image capture device 12 to lie outside the subject's face and either above or below the corresponding feature, as a function of the relative heights of the subject 30 and the light source 16. A relatively large portion of the shadows 36a and 36b lie outside the head 32 when viewed straight on from the capture stand 10. The shadows 36a and 36b are visible to the image capture device 12, shown by way of example here as a video camera and lens, which receives a plurality of light beams 24a-24n forming the shadows 36a and 36b and the captured digital image, an example of which is shown is FIG. 3.

Referring now to FIG. 3, an illustrative digital image 40 of a subject captured with the arrangement of FIG. 2 and the prior art capture stand and lighting device of FIG. 1 includes specular reflections 42a and 42b from the subject's glasses and bifocal lenses 47, uneven skin tones 44 caused by the strobe lighting and shadows 46a and 46b from the subject's ears 48 and hair 49 which appear on the backdrop 28 (FIG. 2) and the subject's hair 49.

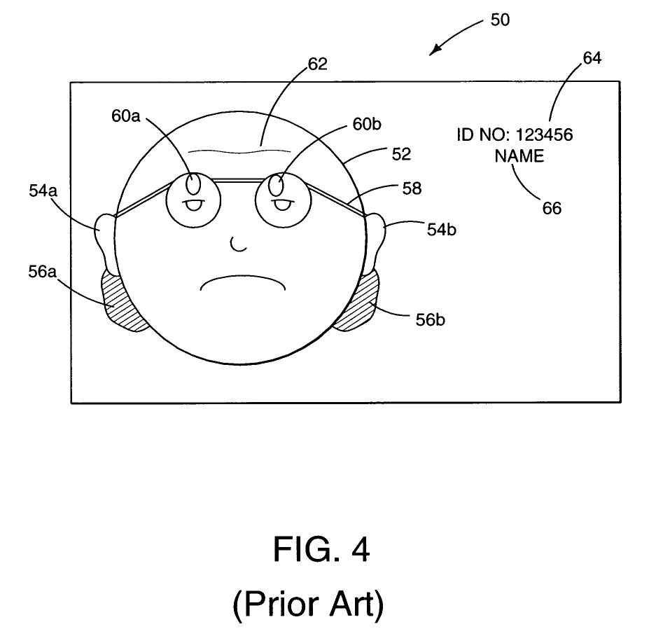

Referring now to FIG. 4, a prior art grayscale identification document 50 produced using the digital image 40 of FIG. 3 includes a portrait 52 of the subject and demographic data such as an identification number 64 and the subject's name 66. Lighting problems in the digital image 40 are reproduced in the identification document 50, such as shadows 56a and 56b (generally referred to as shadows 56). In this example, the shadows 56 are disposed below the subject's ears 54a and 54b. It should be understood, however, that the location of the shadows 56 is not limited to being below the ears. Those skilled in the art will appreciate that the shadows 56 could appear elsewhere in the image, such as under a hair line, along a neck, under a nose, etc., etc. Bright spots 60a and 60b appear on the subject's glasses 58. Uneven skin tones 62 also appear on the subject's forehead because of direct specular reflection from the strobe off the subject's forehead and into the image capture device 12 (FIG. 2). As shown in this identification document 50, the shadows 56 are intensified because the identification document 50 has a limited number of grayscale levels to represent the image. The lighting problems cause similar effects on full color identification documents, although the shadows may be relatively less pronounced as compared to those in a grayscale image.

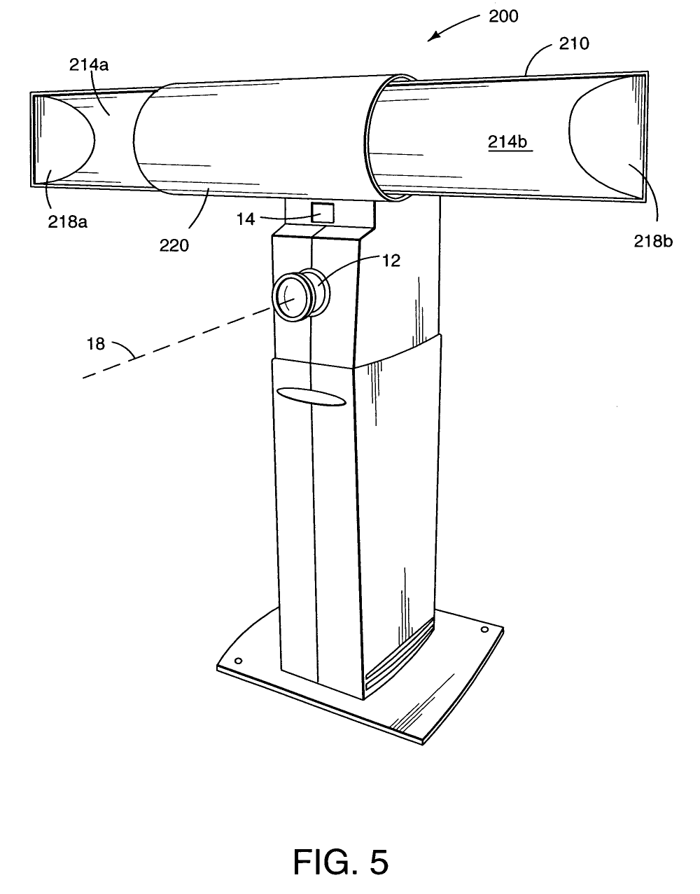

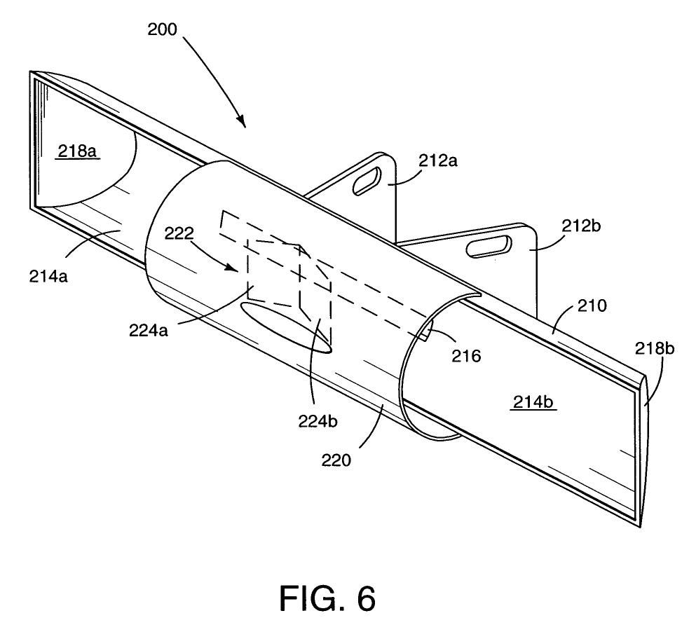

Referring now to FIG. 5, an exemplary lighting device 200 according to one embodiment of the invention includes a housing 210 which includes diffusely reflective inner surfaces 214a and 214b coupled to diffusely reflective end portions 218a and 218b, respectively. The lighting device 200 further includes a diffuser 220 disposed on the housing 210. A reflector 222 is not visible in FIG. 5, but is shown in FIG. 6, which provides a perspective view of the lighting device 200 of FIG. 5. In one embodiment, the lighting device 200 is adapted to mount directly onto a capture stand, such as the prior art capture stand 10 of FIG. 1, without requiring any changes to the workstation control software and hardware and without modification to the image capture device 12, the light sensor 14, and the light source 16 (not shown in this view). The image capture device 12 has an observation axis 18 which is generally aligned with light reflected from the inner surfaces 214a and 214b directed onto the subject. It will be appreciated by those of ordinary skill in the art that image capture device 12 may include, but is not limited to, a video camera and associated frame or field capture device, a digital camera, or a CCD or CMOS image sensor. The image capture device 12 can be coupled to the capture workstation (not shown) by means of a video signal interface or a digital interface. The image capture device 12 interface can be hardwired, wireless, or a combination of hardwired and wireless technology.

The lighting device of FIG. 5 can be formed using virtually any material and/or combination of materials, so long as the resultant device is capable of functioning in the manner described. For example, housing 210 of the illustrated lighting device 200 of FIG. 5 was formed using a plastic material, and the diffusively reflective surfaces (214a, 214b, 218a, 218b) within it were created by coating the surfaces with a light colored paint. Those skilled in the art will appreciate, however, that the housing 210 and/or the diffuser 220 can be formed using virtually any type of material capable of being formed into the desired shape and (in the case of the diffuser) providing the desired optical properties, including but not limited to metal, paper, cardboard, glass, fabric, paper, wood, cardboard, paperboard, ceramic, rubber, along with many man-made materials, such as microporous materials, single phase materials, two phase materials, coated paper, synthetic paper (e.g., TYVEC, manufactured by Dupont Corp of Wilmington, Del.), ABS, polycarbonate, polyolefin, polyester, polyethylenetelphthalate (PET), PET-G, PET-F, and polyvinyl chloride (PVC), and combinations thereof. In one experiment, the inventors found that a satisfactory housing 210 could even be formed using a section of six (6) inch diameter white plastic plumbing pipe.

Many different methods of forming the housing 210 are usable, including milling, pressure forming, injection molding, stamping, welding, coupling several individual elements together using adhesive, screws, staples, etc.,

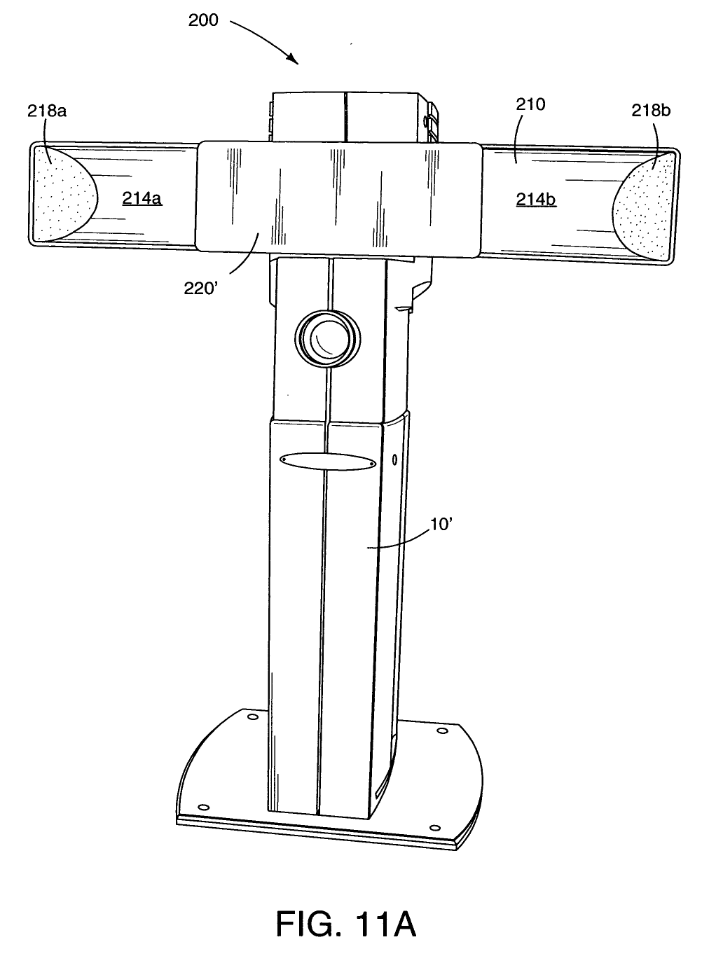

Further, the diffuser 220 is not limited to the shape or configuration shown in FIG. 5 (and FIG. 6). FIGS. 11-13 herein provide another illustrative example of a diffuser usable in accordance with at least one embodiment of the invention. The diffuser 220 can be virtually any shape or size that is capable of diffusing the light reflected back at it by the reflector 222 and the light that reaches it through the aperture 216 (see FIG. 6).

In at least one embodiment of the invention, the materials used for the diffuser 220 and those used on one or more of the diffusively reflective surfaces 214a, 214b, 218a, 218b, are selected in a particular combination to produce a desired lighting effect on a subject. For example, in one embodiment, for one type of lighting condition, the more translucent the diffuser 220, the more reflective the diffusively reflective surfaces 218a, 218b need to be. The materials used for the diffuser 220 and those used on one or more of the diffusively reflective surfaces 214a, 214b, 218a, 218b, also can be selected based on the lighting source used and/or the reflector 222. In addition, those skilled in the art will appreciate that the lighting device 200 of FIG. 5 can be implemented using housings, reflectors, diffusers, and materials of varying shapes and types. For example, in one embodiment, the diffusively reflective inner surfaces 214a, 214b and the diffusively reflective end portions 218a, 218b are formed from the same material. In one embodiment, the diffusively reflect inner surfaces 214a and 214b comprise a different surface material than the diffusively reflective end portions 218a and 218b.

Further, the housing 210 can have virtually any shape so long as the shape is conducive to permitting light to illuminate a subject as desired. Experimentation has shown that shapes that have at least some curvature to them (e.g., shapes having curved portions, such as cylindrical shapes, parabolic shapes, round shapes, etc.) have been found to be advantageous, but the invention is not limited to shapes with curvature. It is not required, however, that the curved portion (or any other portion) has a smooth surface.

Referring now to FIG. 6, an exemplary lighting device 200 of one embodiment of the invention, which embodiment which is similar to the lighting device of FIG. 5 includes a housing 210 having mounting brackets 212a and 212b and an aperture 216 centrally disposed in the housing 210 and aligned with a capture station light source (not shown) when the device 200 is mounted to the capture station. The mounting brackets 212a, 212b are, of course, but one means by which the lighting device 200 can be mounted to the rest of the system in which it is to be used. The mounting brackets 212a, 212b could, for example, be replaced by clips, slots (or other structures) adapted to mate with a matching member on the apparatus to which the lighting device 200 is to be attached, adhesives, welds, or virtually any article or substance for joining one item to another. Note also that the mounting of the lighting device 200 need not be fixed, but can be movable.

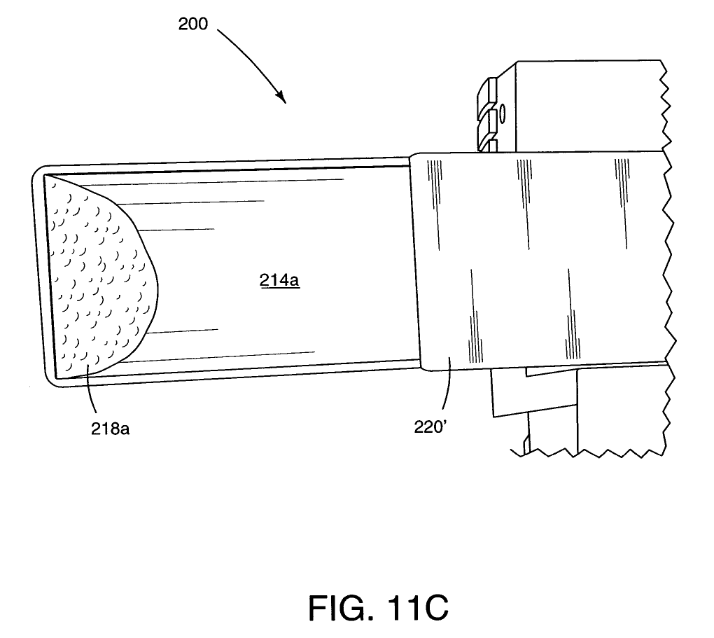

The housing 210 further includes diffusely reflective inner surfaces 214a and 214b coupled to diffusely reflective end portions 218a and 218b, respectively. The lighting device 200 further includes a diffuser 220 disposed on the housing 210 and a reflector 222. In the embodiment of the invention illustrated in FIG. 6, the reflector 222 includes a pair of specularly reflective surfaces 224a and 224b. In one embodiment, the specularly reflective surfaces 224a, 224b are mirrors or mirror-like surfaces. In one embodiment (shown in FIG. 13), the specularly reflective surfaces 224a, 224b of the reflector 222 are fixedly coupled together (and can even be formed as a unitary member) In one embodiment, the entire housing 210 inner surface including portions behind the diffuser 220 and surrounding the aperture 216 comprises diffusely reflective inner surfaces. It will be appreciated, however, that the diffusively reflective surfaces need not all be formed from the same material. For example, in one embodiment (illustrated in FIGS. 11A-C), the diffusively reflective end portions 218a, 218b have diffusively reflective surfaces formed from a different material than the rest of the diffusively reflective surfaces in the housing 210. It also will be appreciated by those of ordinary skill in the art, that the lighting device 200 light source 16 can be mounted together and separated from the image capture device 12 (FIG. 5).

In at least some embodiments of the invention, at least one or more of the inner surfaces 214a, 214b, 218a, 218b of the housing 210 are specularly reflective. Using a specularly reflective surface can increase the light transmitted to the subject being illuminated, but use of too many specularly reflective surfaces may increase and/or alter the shadows in an undesirable manner.

In one embodiment, the housing 210 includes, e.g., one half of a four-inch diameter plastic pipe. In this embodiment this housing 210 is approximately 24 inches long. Portions of the inner surfaces 214a and 214b of the housing 210 which reflect light from the reflector 222 onto the subject are coated with a white, opaque, diffusely reflective material. In one embodiment, the inner surfaces 214a and 214b are painted with a white matte finish paint, for example, Flat White 1502 Krylon ® manufactured by the Sherwin-Williams Company. In one embodiment, the diffuser 220 is a semi-cylindrical translucent plastic material attached to the housing. In this embodiment, the specularly reflective surfaces of the reflector 222 include a pair of mirrors 224a and 224b attached to the diffuser 220 and arranged directly in front of the light source, here an electronic strobe (not shown in FIG. 6). In this embodiment, the reflector 222 is sized and angled so that it is as wide as the size of the flash of the strobe, to be able to reflect the light. Note also that the invention can be used with non-electronic strobes, pulsed strobes, and many other types of light sources.

The mirrors 224a and 224b (or other highly reflective surfaces) are configured at a 90 degree angle with respect to each other, and each mirror 224 forms a 45 degree angle with the exit aperture plane of the light source, such that light is reflected from the light source off the mirrors 224 and off the inner surfaces 214a and 214b and the end portions 218a and 218b of the housing 210 onto the subject. In this embodiment, the mirrors 224a and 224b intercept more than fifty percent of the illumination from the light source passing through the aperture 216. In one embodiment, the mirrors intercept about 67 percent of the illumination. The mirrors 224a and 224b optionally include an antireflective coating. It should be noted that the reflector 222 need not have the rectangular shape shown, but can be virtually any shape (e.g., round, triangular, octagonal etc.

It will be appreciated that the particular angles shown for the reflector 222 are not limiting and can be any angle capable of permitting light from the light source to reach the subject being illuminated.

It also will be appreciated by those of ordinary skill in the art that the dimensions, angles, diffuser materials and inner surface coating materials can be varied to accommodate different capture stands, light sources and subject and backdrop arrangements. This is discussed further below.

In this embodiment, the end portions 218a and 218b are arranged at an angle, e.g. a 45-degree angle with respect to the inner surfaces 214a and 214b and coated with the same diffuse reflecting coating as the inner surfaces 214a and 214b. Of course, the invention is not limited to end portions 218a, 218b arranged at a specific angle. Generally, the angle at which the end portions 218a, 218b are arranged will be selected based at least in part on the angle of the reflector 222. For example, in the embodiment of FIG. 6, the angle of the end portions 218a, 218b is substantially the same as the angle of the exit aperture plane of the light source. However, depending on the application, it may be desirable for the end portions 218a, 218b to be at a substantially different angle than that of the exit aperture plane of the light source. Thus, it will be appreciated by those of ordinary skill in the art that both the area of the inner surfaces 214a and 214b and the alignment of the orientation of the light reflected from the inner surfaces 214a and 214b with respect to the observation axis 18 can be varied without substantially affecting the size and location of visible shadows.

Referring again to FIGS. 5 and 6, in operation, a predetermined portion of the light from the light source is reflected by the reflector 222 and re-directed by the inner surfaces 214a and 214b and the end portions 218a and 218b of the housing 210 such that the subject is illuminated with diffuse light that effectively functions as indirect side lighting which may eliminate most of the visible shadows on the backdrop or on the subject's hair which are captured by the image capture device. The reflected illumination is directed from two sources corresponding to the inner surface 214a and the end portion 218a, and the inner surface 214b and end portion 218b, respectively. A projection of these sources onto a plane orthogonal to the observation axis 18 lies substantially outside a projection of the subject's head onto the same plane.

The remainder of the light, which is not reflected by the reflector 222, passes through the diffuser 220 and is transmitted to indirectly illuminate the subject. Therefore the light source does not directly illuminate the subject because the illumination is balanced between diffused lighting in a face-on direction and diffused reflective side lighting. The diffuser 220 also functions as a protective cover concealing the light source and the reflector 222.

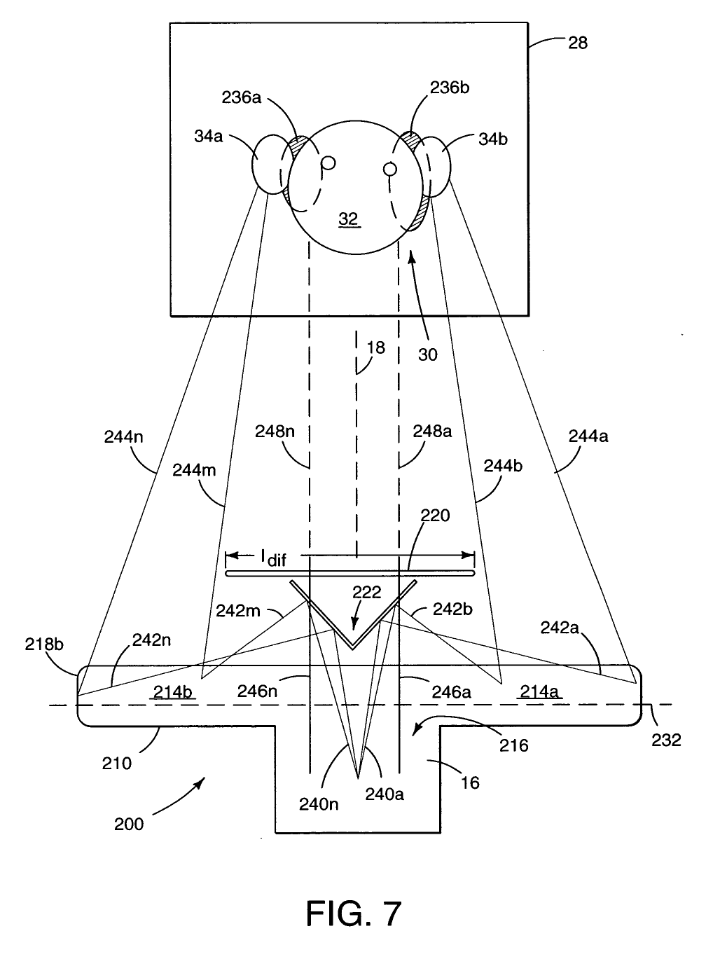

Referring now to FIG. 7, an arrangement for capturing a digital image of a subject 30 located in front of a backdrop 28 includes the capture stand and lighting device 200 of FIGS. 5 and 6, disposed directly facing the subject 30 along the observation axis 18. It has been found that when using the lighting device 200 that varying the color of the backdrop can affect the quality of the shadow reduction. In some conventional applications, use of a blue colored backdrop 28 has been found to provide optimal image quality. However, the instant inventors have found that use of a light colored (e.g., substantially white) backdrop can optimize the shadow reduction features of the lighting device. Use of a light colored backdrop may be particularly advantageous when a lighting device 200 in accordance an embodiment of the invention is used as part of a system to capture images that are to be printed or laser engraved in grayscale or black and white. Of course, the invention is not limited to the production of these types of images.

Referring again to FIG. 7, the subject 30 has a head 32 and ears 34a and 34b. Typically the ears 34a and 34b are disposed on the sides of the head 32 and protrude slightly from the head 32. When commanded by the capture workstation (not shown), the light source 16 provides illumination which can be considered a plurality of light beams 240a-240n and 246a-246n which are directed through the aperture 216 toward the reflector 222. The light beams 240a-240n are reflected off the reflector 222 and become beams 242a-242n which are reflected off of diffusely reflective inner surfaces 214a and 214b and diffusely reflective end portions 218a and 218b and become beams 244a-244n which are directed toward the subject 30.

Other light beams 246a-246n are directed through the aperture 216 toward the diffuser 220. The beams 246a-246n emerge from the diffuser 220 as diffuse light beams 248a-248n and are directed toward the subject 30. Because the light beams 248a-248n have been diffused by the diffuser 220, any light spot reflections from glasses are reduced and the skin tone appearance is improved over the prior art lighting arrangement (FIG. 2). Additionally, since the width of the diffuser 220 (measured along a longitudinal axis 232 of the housing 210) is, in one embodiment, sized so as to be wider than the width of the subject's head 32 (or the width of whatever subject is being illuminated), much of the light illuminating the subject effectively is coming from the both sides of the subject instead of directly in from of the subject. The diffusely reflective end portions 218a and 218b are arranged to further direct light from the reflector 222 onto the subject. Although the shadows 236a and 236b are formed on a backdrop 28, the shadows 236a and 236b are only partially visible to the image capture device 12 which receives a plurality of light beams (not shown) forming the shadows 236a and 236b. Relatively large portions of the shadows 236a and 236b lie behind the head 32 when viewed by the image capture device 12 along observation axis 18.

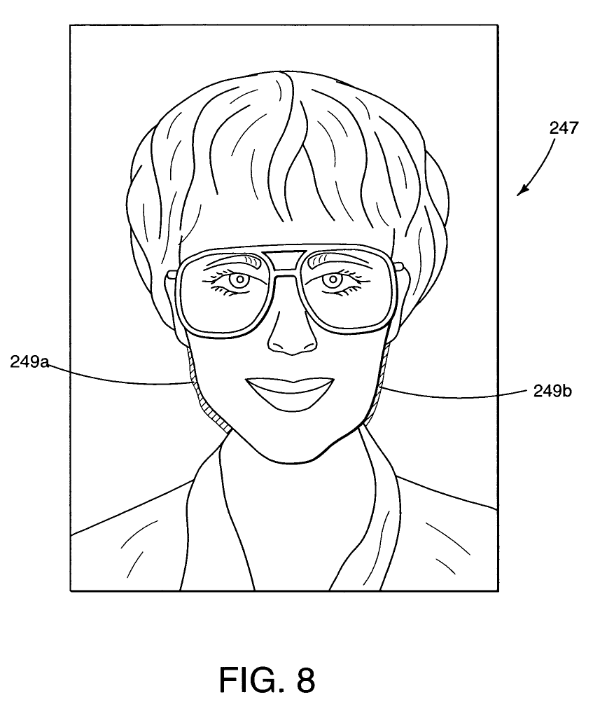

Referring now to FIG. 8, a digital image 247 of a subject captured with the arrangement of FIG. 7 and the lighting device of FIGS. 5 and 6, in accordance with an embodiment of the invention, shows that the shadows 247a and 247b on the backdrop 28 are substantially eliminated (FIG. 7). The exemplary image 247 does not include substantive specular reflections uneven skin tones, which are present in the prior art image 40 of FIG. 3.

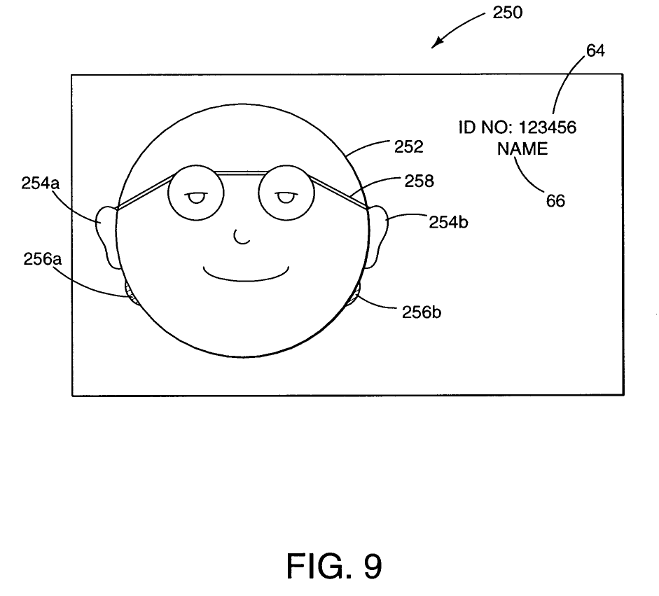

Referring now to FIG. 9, a grayscale identification document 250 that can be produced using the image 240 of FIG. 3 includes a portrait 252 of the subject and demographic data such as an identification number 64 and the subject's name 66. By using the lighting device 200 (FIGS. 5 and 6), lighting problems including shadows, bright specular reflections from glasses, and skin tone problems in the digital image 40 are greatly reduced in the identification document 250. As shown in this identification document 250, the shadows 256a and 256b are reduced when compared to the prior art identification document 50 of FIG. 2. Note also that the identification document 250 can be a laser engraved identification document, such as the documents that can be created using technology described in commonly assigned application entitled “Laser Engraving Methods and Compositions, and Articles Having Laser Engraving Thereon”, Ser. No. 10/326,886, filed Dec. 20, 2002, Attorney Docket NO. P0724D, which is incorporated by reference.

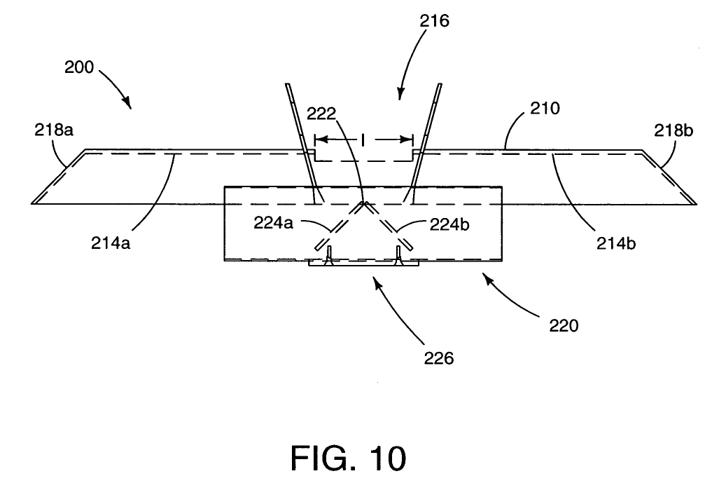

Referring now to FIG. 10 in which like reference numbers indicate like elements of FIGS. 5 and 6, the exemplary lighting device 200 further includes a reflector mount 226 which is coupled to the diffuser 220. In one embodiment, the aperture 216 has a length I of approximately 3.5 inches and a width of approximately 2 inches, the diffuser is approximately 10 inches, and a plane of the housing 210 forms an angle of 45 degrees with a plane of the diffusely reflective end portions 218a and 218b, respectively. Of course, these dimensions are not limiting, but rather are provided by way of example.

In one embodiment of the invention, a lighting device (not shown) includes a light source disposed within the housing and a light sensor disposed on the housing to receive light reflected from the subject. The light source is coupled to a light source control disposed either internally within the housing or external to the housing.

FIGS. 11A-C are front, side, and enlarged schematic views, respectively, of a lighting device 200 in accordance with one embodiment of the invention. The lighting device 200 is shown coupled to a capture stand 10′ similar to the capture stand 10 of FIG. 1. FIG. 11C is an enlarged view of section 400 of FIG. 11A. FIGS. 11A-C illustrate a lighting device 200 in which the diffusively reflective end surfaces 218a, 218b are of a different material than the diffusively reflective inner surfaces 214a, 214b. Referring to FIG. 11C, in this embodiment, the diffusively reflective end surfaces 218a, 218b comprise so-called “supersoft” reflector material capable of producing wide lighting coverage over short distances. One example of a usable reflector material for the diffusively reflective end surfaces 218a, 218b is Roscoflex SS #3804, which is available from Rosco Laboratories, Inc., of Ontario Canada. In addition, the instant inventors have found that a wide range of diffusively reflective materials are usable on the diffusively reflective end surfaces 218a, 218b, including mirrors and mirror-like surfaces, metallic foils, metallic mesh, grated surfaces, metallic coatings, textured coatings, textured reflective materials, etc. The diffusively reflective end surfaces 218a, 218b can be formed using combinations of materials, as well. For example, the diffusively reflective end surface 218a could comprise an outer “ringed” portion of Roscoflex #3804 with an inner portion of mirrored material. Those skilled in the art will appreciate that many combinations of materials are usable.

In the embodiment of FIGS. 11A-C, the diffusively reflective inner surfaces 214a, 214b of the lighting device 200 are formed by applying two layers of light colored semi gloss paint over the surface of the housing (which in this embodiment is plastic, by way of example only). The first layer of semi gloss paint is applied then, before that layer is completely dry, another layer is applied over it. This technique has been found to further improve the diffusive properties.

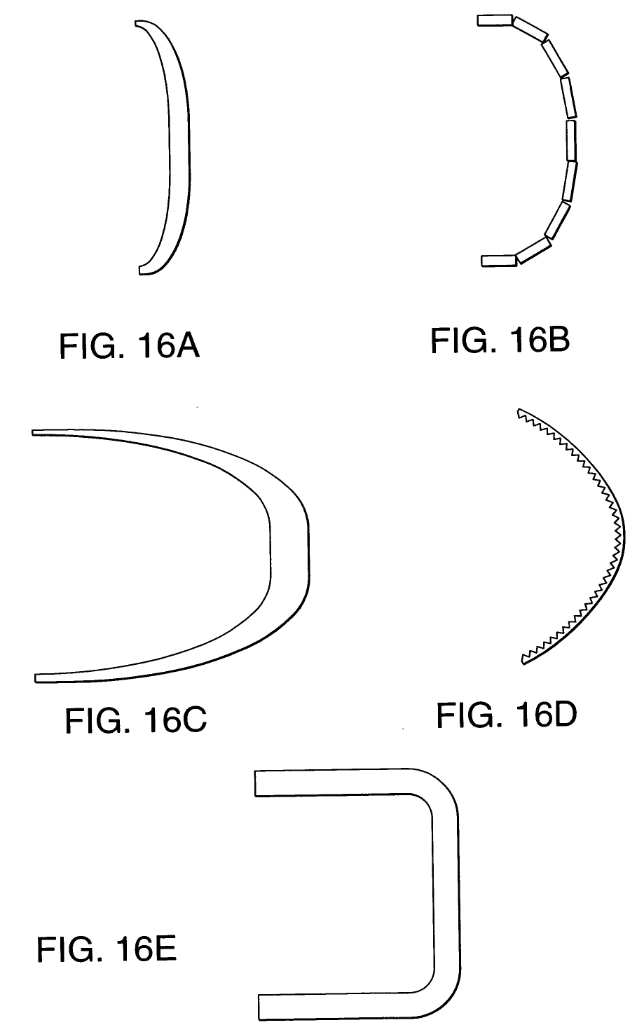

The resultant diffusively reflective inner and end surfaces 214a, 214b, 218a, 218b need not be completely or even partially smooth, so long as the light is able to be properly reflected and/or diffused. For example, in the embodiment of FIGS. 11A-C, the diffusively reflective end surfaces 218a, 218b have a tactile texture (because of the Roscoflex #3804) whereas the diffusively reflective inner surfaces 214a, 214b have a texture that is less pronounced. FIG. 16, described further herein, provides illustrative examples of surfaces that can be used in at least some embodiments of the invention.

Further, although the lighting device 200 is illustrated as having a curved, at least partially semi-cylindrical shape, the invention is not so limited. In one embodiment, the lighting device 200 can be virtually any shape (e.g., substantially conical, triangular, rectangular, square, elliptical, parabolic, trapezoidal, etc.), so long as at least a portion of the lighting device 200 is curved, even if the curve is relatively flat and/or irregular.

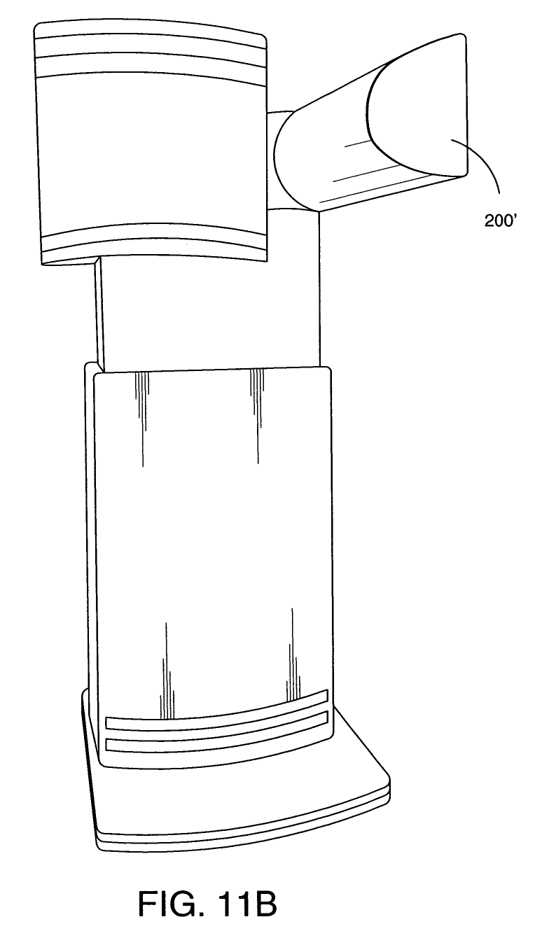

Referring again to FIG. 11A, in this embodiment, the diffuser 220′ of the lighting device 200 differs from the diffuser 200′ of the lighting device of FIGS. 5 and 6. In this embodiment, the diffuser 220′ has a substantially flat shape and is coupled to the top and bottom of the housing 210. This is illustrated further in FIG. 12, which is a diagrammatic front perspective view of a portion of the lighting device 200 of in FIG. 11A, in accordance with one embodiment of the invention. Although the shape of the diffuser 220′ differs from the diffuser 220 of FIGS. 5 and 6, like the earlier diffuser 220, the diffuser 220′ can be formed from any material (or combination of materials) capable of diffusing light while permitting a portion of the light to transmit therethrough (to illuminate at least the front of the subject). In the embodiment shown in FIG. 11A, the diffuser 220′ is formed into a substantially rectangular shape and comprises LEXAN, which is available from General Electric Corporation, GE Plastics, Pittsfield, Mass.

Other materials usable for the diffuser 220 include virtually all known light diffusing materials, such as frosted and textured glass and plastic, fabric, thin plastic films, latex, paper, synthetic paper, laminates, transparent materials coated with light diffusing coatings, glazes, etc.,

FIG. 13 is a diagrammatic exploded perspective view of the lighting device 200 of FIG. 12, showing illustrative embodiments of the housing 210, reflector 222, and diffuser 220′. The housing 210 has formed thereon aperture 216 through which the light source (not shown) is able to transmit and be reflected off the reflecting surfaces 224a, 224b as well as be diffused through the diffuser 220′, and be further diffused and reflected off the diffusively reflective end surfaces 218a, 218b. The reflector 222 can be coupled to either the housing 210 or the diffuser 220′. The diffuser 220′ can be directly coupled to the housing 210 or can be coupled to the reflector 222, which can be coupled to the housing 210. The methods by which the diffuser 220′, reflector 222, and housing 210 are attached to each other are not important, so long as the attachment method substantially prevents light passing through the aperture 216 from directly impinging on the subject whose image is being captured, to help prevent the formation of shadows (or at least reduce the size of the shadows) in the image.

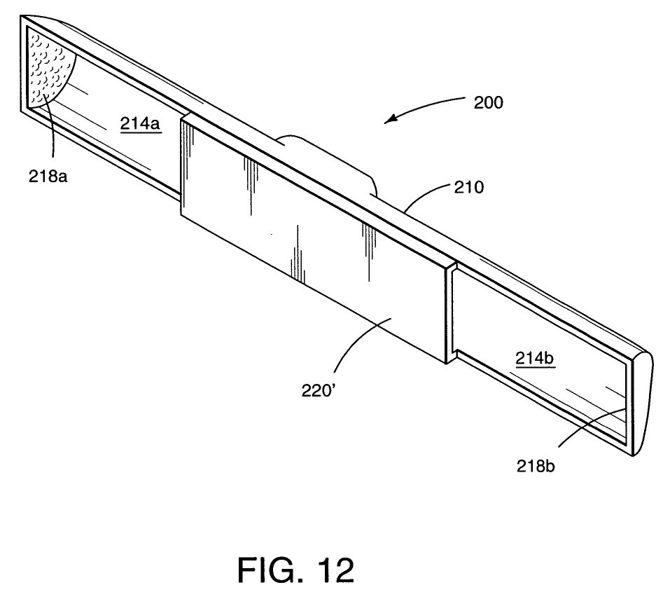

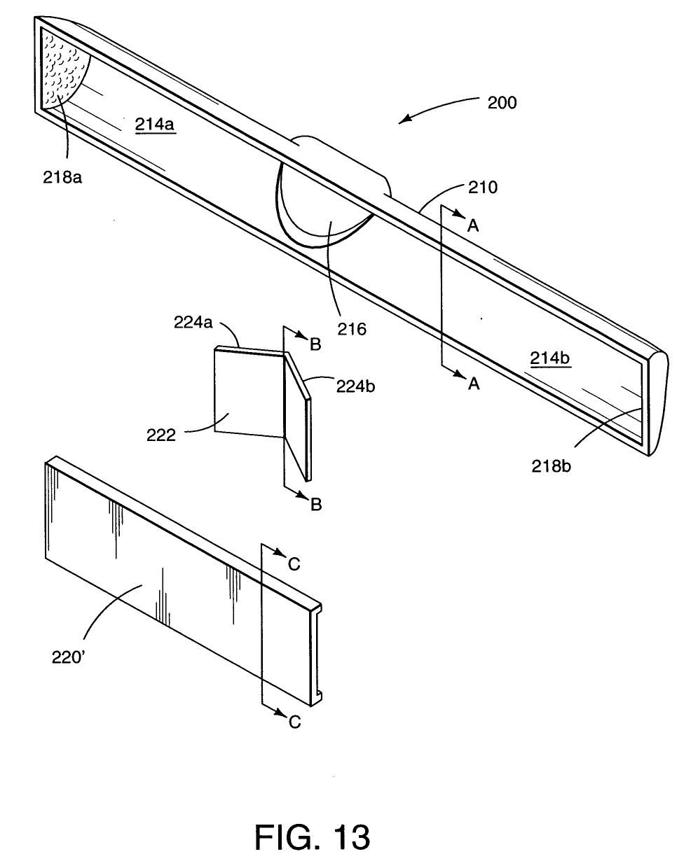

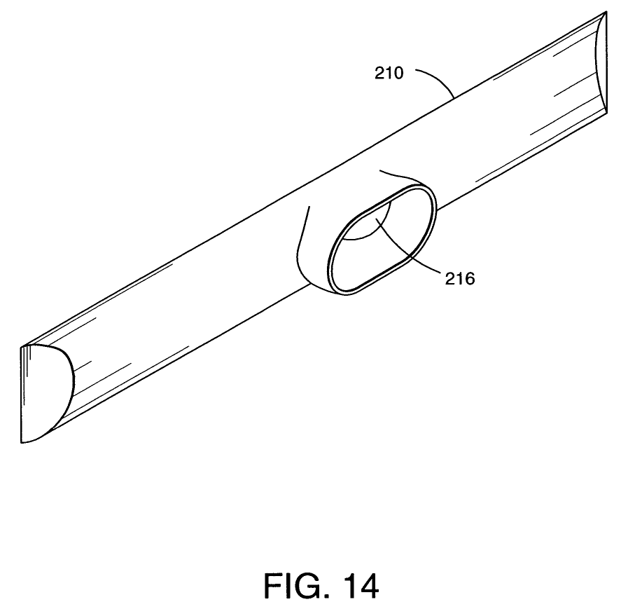

FIG. 14 is a diagrammatic rear perspective view of the lighting device of FIG. 12, illustrating the formation of the aperture 216.

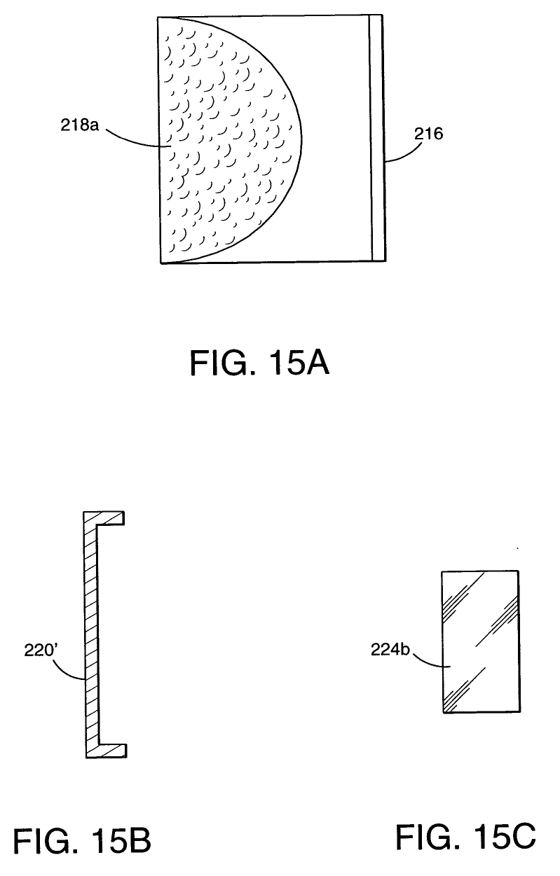

FIGS. 15A-C are illustrative cross sectional views taken along the A-A, B-B, and C-C lines, respectively, of FIG. 12. FIG. 15A shows a cross sectional view of the housing 210, showing both the aperture 216 and one the diffusively reflective end surface 218a. FIG. 15B shows a cross sectional view of the reflector 222, showing a specularly reflective surface 224b. FIG. 15C shows an illustrative cross sectional view of the diffuser 220′.

FIGS. 16A-E are illustrative examples of cross sectional views of some embodiments of the lighting device 200 of FIG. 12. These cross sectional views are not, of course, exhaustive in showing the many ways the lighting device 200 can be implemented, but help to illustrate various usable shapes. FIG. 16A shows a substantially flat cross sectional surface possessing a slight curvature. The cross sectional surface of FIG. 16A could, for example, be part of a lighting device 200 having a virtually any shape—rectangular, square, elliptical, triangular, etc. FIG. 16B shows how a plurality of substantially straight surfaces (e.g., like the many mirrored surfaces of a “disco ball”) can be coupled together, constructed, and arranged, to form a lighting device 200 having a curved cross section. FIG. 16C shows a cross section having a significant degree of curvature. FIG. 16D shows a cross section with some curvature, but which has a highly textured, non-smooth surface. The surface of FIG. 16D can, for example, comprise a plurality of ridges, raised “bumps”, indentations (e.g., like a golf ball), and the like. FIG. 16E shows a cross section that comprises mostly straight surfaces with rounded edges, which also is usable with at least some embodiments of the invention.

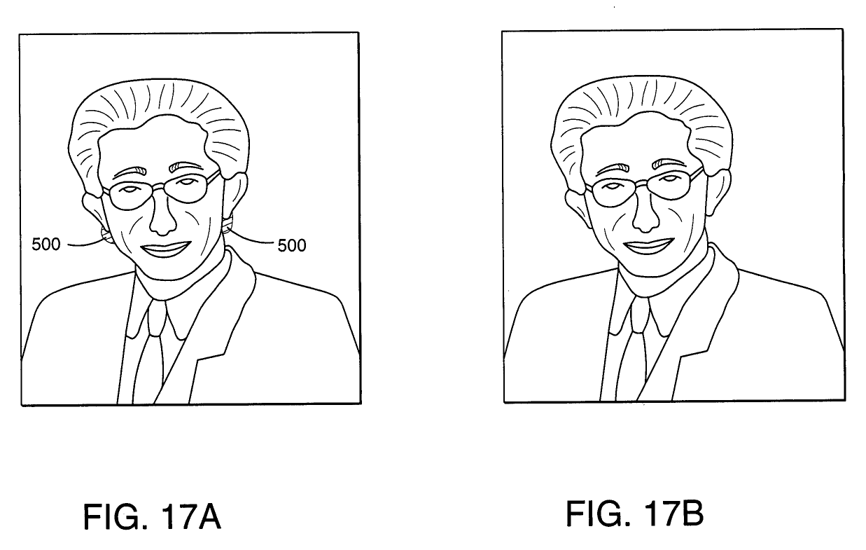

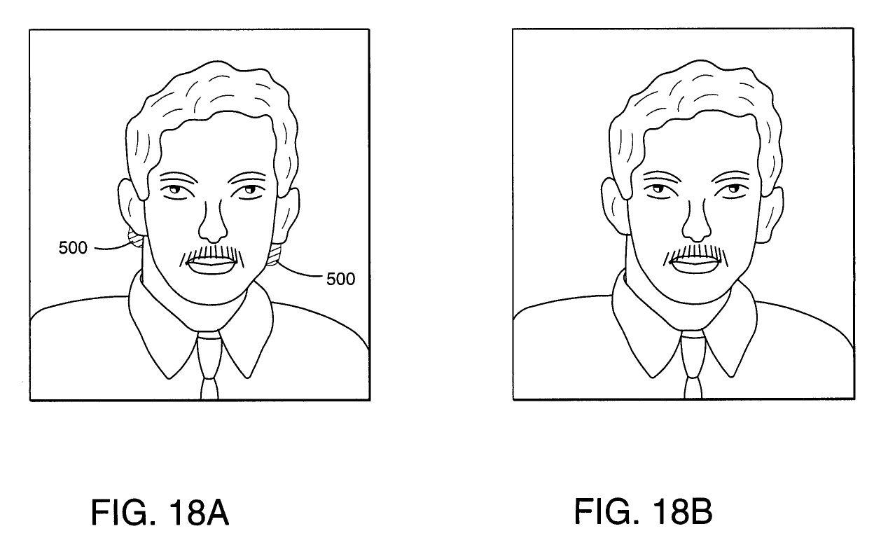

FIGS. 17A and 17B are illustrative examples of captured “before and after” images, respectively, of a first subject, taken without and with the use of the lighting device 200 of FIGS. 11A-11C. In the “before” shot of FIG. 17A, shadows 500 are visible under the ears of the subject, whereas in the “after” shot of FIG. 17B, the shadows 500 have been substantially eliminated through use of the lighting device 200 of FIGS. 11A-11C. FIGS. 18A (before) and 18B (after) show similar improvement in ear and neck shadows 500 of a second subject.

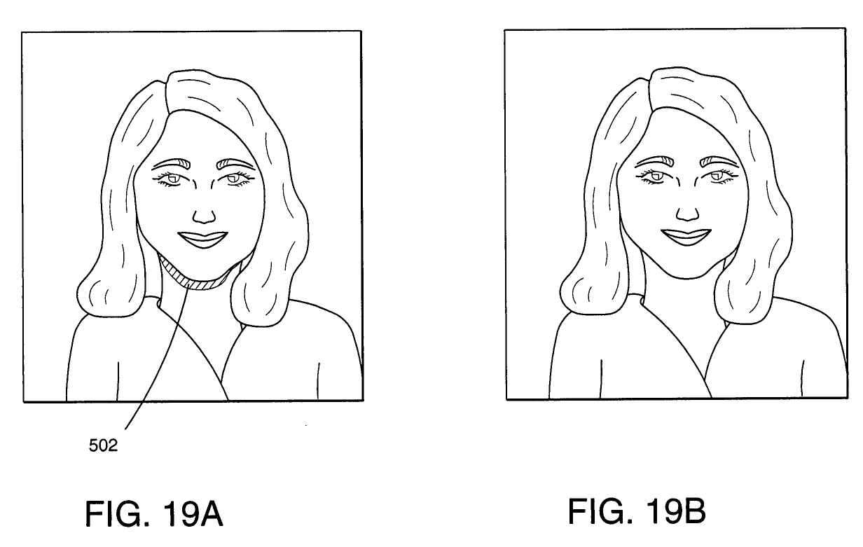

FIGS. 19A and 19B are illustrative examples of captured “before and after” images, respectively, of a third subject, taken without and with the use of the lighting device of FIGS. 11A-11C. In the “before” image of FIG. 19A, the image of the third subject has chin shadows 502. Re-taking the image using the lighting device 200 of FIGS. 11A-11C helps to substantially reduce the chin shadows 502, as shown in FIG. 19B.

It is believed that the lighting device 200 described herein, as well as many other embodiments of the invention, have the ability to reduce many other types of shadows, glare, etc., and the illustrations herein are not intended to be limiting in that respect.

We also note that our invention has applicability in any environment where high quality captured images are desired. For example, we specifically contemplate that our invention can be used to capture images that are to become part of a biometric systems, such as a facial recognition system, and we anticipate that the high quality images captured using the embodiments of the invention described herein can be used to improve the operation and/or accuracy of facial recognition systems, including the systems described in commonly assigned applications: “Systems and Methods for Recognition of Individuals Using Combination of Biometric Techniques (application Ser. No. 60/418,129, Attorney Docket No. P0698D, filed Oct. 11, 2002—Inventors James V. Howard and Francis Frazier); and Systems and Methods for Managing and Detecting Fraud in Image Databases Used With Identification Documents (application Ser. No. 60/429,501, Attorney Docket No. P0718D, filed Nov. 26, 2003—Inventors James V. Howard and Francis Frazier).

We also specifically anticipate that at least some embodiments of the invention described herein may be useful to improve the quality of images used with digital watermarking or other steganographic encoding. For example, we anticipate that a steganographic code can be embedded into all or part of an image captured using embodiments of the invention. One form of steganographic encoding is digital watermarking. Digital watermarking is a process for modifying physical or electronic media to embed a machine-readable code into the media. The media may be modified such that the embedded code is imperceptible or nearly imperceptible to the user, yet may be detected through an automated detection process. In some embodiments, the identification document includes two or more digital watermarks.

Digital watermarking systems typically have two primary components: an encoder that embeds the digital watermark in a host media signal, and a decoder that detects and reads the embedded digital watermark from a signal suspected of containing a digital watermark (a suspect signal). The encoder embeds a digital watermark by altering the host media signal. The reading component analyzes a suspect signal to detect whether a digital watermark is present. In applications where the digital watermark encodes information, the reader extracts this information from the detected digital watermark. The reading component can be hosted on a wide variety of tethered or wireless reader devices, from conventional PC-connected cameras and computers to fully mobile readers with built-in displays. By imaging a watermarked surface of the card, the watermark's “payload” can be read and decoded by this reader.

Several particular digital watermarking techniques have been developed. The reader is presumed to be familiar with the literature in this field. Some techniques for embedding and detecting imperceptible watermarks in media signals are detailed in the assignee's co-pending U.S. patent application Ser. No. 09/503,881, U.S. Pat. No. 6,122,403 and PCT patent application PCT/US02/20832, which are each herein incorporated by reference.

For example, a watermark embedded in the image may include a payload or message. The message may correspond, e.g., to the ID document number, printed information, issuing authority, biometric information of the bearer, and/or database record, etc. The watermark embedded in the image may also include an orientation component, to help resolve image distortion such as rotation, scaling and translation. The watermark embedded in the image also can correspond to information printed on the ID document, or to information carried by a second watermark embedded elsewhere on the ID document (e.g., background pattern, etc.). More techniques for digital watermarks and ID cards can be found in Digimarc's U.S. Provisional Patent application No. 60/421,254, U.S. patent application Ser. No. 10/094,593, and in U.S. Pat. No. 5,841,886. Each of these patent documents is incorporated herein by reference. We expressly contemplate that the techniques disclosed in this application can be combined with the aspects of the present invention.

Concluding Remarks

Having described and illustrated the principles of the technology with reference to specific implementations, it will be recognized that the technology can be implemented in many other, different, forms, and in many different environments. The technology disclosed herein can be used in combination with other technologies. Also, instead of ID documents, the inventive techniques can be employed with product tags, product packaging, labels, business cards, bags, charts, smart cards, maps, labels, etc., etc. The term ID document is broadly defined herein to include these tags, maps, labels, packaging, cards, etc.

It should be appreciated that some illustrations herein illustrate a particular species of ID document—a driver's license—the present invention is not so limited. Indeed our inventive methods and techniques apply generally to all identification documents defined above. Moreover, our techniques are applicable to non-ID documents, e.g., such as printing or forming covert images on physical objects, holograms, etc., etc. Further, instead of ID documents, the inventive techniques can be employed with product tags, product packaging, business cards, bags, charts, maps, labels, etc., etc., particularly those items including providing a high quality indicia, such as an image information on an over-laminate structure. The term ID document is broadly define herein to include these tags, labels, packaging, cards, etc. For example, it is contemplated that aspects of the invention may have applicability for articles and devices such as compact disks, consumer products, knobs, keyboards, electronic components, decorative or ornamental articles, promotional items, currency, bank notes, checks, etc., or any other suitable items or articles that may record information, images, and/or other data, which may be associated with a function and/or an object or other entity to be identified.

It should be appreciated that the methods described above as well as the methods for implementing and embedding digital watermarks, can be carried out on a general-purpose computer. These methods can, of course, be implemented using software, hardware, or a combination of hardware and software. Systems and methods in accordance with the invention can be implemented using any type of general purpose computer system, such as a personal computer (PC), laptop computer, server, workstation, personal digital assistant (PDA), mobile communications device, interconnected group of general purpose computers, and the like, running any one of a variety of operating systems. We note that some image-handling software, such as Adobe's PrintShop, as well as image-adaptive software such as LEADTOOLS (which provide a library of image-processing functions and which is available from LEAD Technologies, Inc., of Charlotte, N.C.) can be used to facilitate these methods, including steps such as providing enhanced contrast, converting from a color image to a monochromatic image, thickening of an edge, dithering, registration, manually adjusting a shadow, etc. etc. Computer executable software embodying the steps, or a subset of the steps, can be stored on a computer readable media, such as a diskette, removable media, DVD, CD, hard drive, electronic memory circuit, etc.).

Moreover, those of ordinary skill in the art will appreciate that the embodiments of the invention described herein can be modified to accommodate and/or comply with changes and improvements in the applicable technology and standards referred to herein. Variations, modifications, and other implementations of what is described herein can occur to those of ordinary skill in the art without departing from the spirit and the scope of the invention as claimed.

Although certain words, languages, phrases, terminology, and product brands have been used herein to describe the various features of the embodiments of the invention, their use is not intended as limiting. Use of a given word, phrase, language, terminology, or product brand is intended to include all grammatical, literal, scientific, technical, and functional equivalents. The terminology used herein is for the purpose of description and not limitation.

The particular combinations of elements and features in the above-detailed embodiments are exemplary only; the interchanging and substitution of these teachings with other teachings in this and the incorporated-by-reference patents/applications are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

All publications and references cited herein are expressly incorporated herein by reference in their entirety. Having described the preferred embodiments of the invention, it will now become apparent to one of ordinary skill in the art that other embodiments incorporating their concepts may be used. These embodiments should not be limited to disclosed embodiments, but rather should be limited only by the spirit and scope of the appended claims.

What is claimed is:

1. A lighting device that illuminates an object from a light source, comprising:
a housing having at least one inner surface portion that is diffusely reflective;
an aperture disposed in the housing, the aperture aligned with the light source;
a diffuser disposed between the light source and the object; and
a reflector disposed adjacent the aperture between the light source and the diffuser

2. The lighting device of claim 1 wherein the light source has illumination, wherein:
the reflector is constructed and arranged to intercept the illumination from the light source;
the diffusively reflective inner surface portion of the housing is constructed and arranged to reflect the illumination intercepted by the reflector; and
the diffuser is constructed and arranged to receive the illumination reflected by the diffusively reflective inner surface of the housing.

3. The lighting device of claim 1 wherein the light source has illumination and wherein the reflector and diffusely reflective inner surface portion are constructed and arranged to reflect substantially all the reflected first portion of the illumination onto the object being illuminated as indirect side lighting, with respect to an observation axis of an image capture device capturing an image of the object.

4. The lighting device of claim 3, wherein the lighting device is constructed and arranged to substantially reduce a visible shadow of the object on a backdrop in an image captured by the image capture device;
the shadow being formed by the object intercepting light from the light source; and
the backdrop being positioned such that the object is disposed between the backdrop and the light source.

5. The lighting device of claim 4 wherein the shadow is substantially located behind the object with respect to the image capture device.

6. The lighting device of claim 1 wherein the reflector comprises a mirror aligned with respect to the light source to reflect a portion of the light towards the diffusely reflective inner surface and onto the object.

7. The lighting device of claim 1 wherein the diffuser comprises a substantially translucent panel capable of diffusing light passing through the panel.

8. Te lighting device of claim 7 wherein the translucent panel comprises a diffusing synthetic plastic material.

9. The lighting device of claim 1 wherein the light source emits a plurality of light rays and wherein the diffuser is positioned to intercept at least a portion of the light rays from the light source within a predetermined steradian angle directed toward the object.

10. The lighting device of claim 9 wherein the diffuser is positioned to intercept substantially all the light rays from the light source within a predetermined steradian angle directed towards the object.

11. The lighting device of claim 1 wherein the light source has an exit aperture plane and wherein the reflector comprises at least two mirrors disposed orthogonal to each other, each mirror disposed at an angle of approximately 45 degrees with respect to the exit aperture plane of the light source.

12. The lighting device of claim 11 wherein the at least two mirrors intercept at least fifty percent of the illumination from the light source passing through the aperture.

13. The lighting device of claim 1 wherein the housing includes a substantially concave portion.

14. The lighting device of claim 1 wherein the object being illuminated has a width and wherein the diffuser has a width greater than the width of the object.

15. The lighting device of claim 1 wherein the housing is disposed between the light source and the object.

16. A lighting device for illuminating an object comprising:
a housing having an inner surface, at least a portion of the inner surface being diffusely reflective;
a light source disposed in the housing;
a diffuser positioned between the light source and the object; and
reflector disposed adjacent the aperture between the light source and the diffuser.

17. The lighting device of claim 16 wherein the light source comprises a strobe.

18. The lighting device of claim 17 wherein the light source further comprises a strobe diffuser operably coupled to on the strobe.

19. A method of illuminating an object with a light source and capturing an image of the object with an image capture device, the method comprising:
providing a diffuser that diffuses light directed directly toward the object; and
reflecting a portion of the light from the light source for illuminating the object such that substantially all the shadows within the field of view of the image capture device are located behind the object.

20. The method of claim 19 further comprising:
providing a backdrop behind the object; and
wherein reflecting a portion of the light comprises providing a pair of mirrors for reflecting a portion of the illumination from the light source off a diffusely reflective surface onto the object.

21. The method of claim 19 wherein the light source is a strobe.

22. A lighting device for illuminating an object from a light source so that an image capture device can capture an image of the object, comprising:
a light source; and
means for illuminating the object such that substantially all shadows of the object within the field of view of the image capture device are located behind the object.

23. A lighting device for illuminating an object from a light source so that an image capture device can capture an image of the object, comprising:
a light source; and
means for converting the light from the light source into indirect side lighting directed onto the object, whereby at least a portion of the visible shadows of the object are reduced.

24. The lighting device of claim 23, wherein the object to be illuminated is disposed adjacent to a backdrop and wherein the means for converting reduces at least a portion of the shadows of the object that would appear on the backdrop in an image captured by the image capture device.

25. The lighting device of claim 1 wherein the housing and the diffuser are integrally formed.

26. The lighting device of claim 16 wherein the housing and the diffuser are integrally formed.

27. A system that captures an image of an object, comprising:
a lighting device that illuminates the object from a light source, the lighting device comprising:
a housing having at least one inner surface portion that is diffusely reflective;
an aperture disposed in the housing, the aperture aligned with the light source;
a diffuser disposed between the light source and the object; and
a reflector disposed adjacent the aperture between the light source and the diffuser; and
an image capture device constructed and arranged to acquire an image of an object that has been illuminated by the lighting device.

28. The system of claim 27 wherein the lighting device is constructed and arranged to provide indirect side lighting to the object to reduce visible shadows of the object in images captured by the image capture device.

29. The system of claim 27 wherein the lighting device is constructed and arranged to have a substantially compact size.

30. The lighting device of claim 4 wherein the shadow is substantially located below the object with respect to the image capture device.

31. A method of capturing an image of an object, comprising:
directing light from a light source directly towards the object;
diffusing the light directed directly toward the object;
reflecting a portion of the light from the light source for illuminating the object such that substantially all the shadows within the field of view of the image capture device are located behind the object; and
capturing an image of the object having substantially reduced shadows, using an image capture device.
